(19) United States
(12) Patent Application Publication
(10) Pub. No.: US 2005/0031417 A1
(43) Pub. Date: Feb. 10, 2005

(54) Gas diffuser ocean water lifting method and device

(76) Inventors: Kurt G. Hofer, Tallahassee, FL (US); John W. Colson, Tallahassee, FL (US)

Correspondence Address: John Wiley Horton, Attorney;Pennington, Moore, Wilkinson,, Bell & Dunbar, P.A., P. O. Box 10095, Tallahassee, FL, 32302-2095, US

(21) Appl. No.: 10/177,531

(22) Filed: Jun. 21, 2002

Related U.S. Application Data
(60) Provisional application No. 60/307,090, filed on Jul. 23, 2001.

(51) Int. Cl. E01H 13/00; A01G 15/00

(52) U.S. Cl. 405/52; 239/2.1

(57) ABSTRACT

A variety of devices capable of bringing ocean water from a considerable depth to the surface using airlift systems. A bubble of air released in the ocean will rise to the surface. If a gas diffuser is employed to release millions of bubbles of air, the rising cloud of bubbles will entrain the surrounding water and pull it toward the surface.

### CROSS-REFERENCES TO RELATED APPLICATIONS

This is a non-provisional application claiming the benefit of an earlier-filed provisional application. The filing data a to the earlier provisional application is as follows:

Inventors: Kurt G. Hoofer and John W. Colon

Title: Gas Diffuser Ocean Water Lifting Method

Filing Date: Jul. 23, 2001

App. No. 60/307,090

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of oceanography. More specifically, the invention comprises a method of using submerged gas diffusers to lift large quantities of deep ocean water toward the surface.

2. Description of the Related Art

Ponds and larger water bodies tend to become stratified into varying temperature layers. The upper layers, being heated by sunlight, become warmer. The lower layers are colder. This phenomenon is well known in the field of commercial aquaculture. In the raising of catfish, as an example, large pumps are employed to periodically pump the colder bottom layer in a holding pond up to the surface.

The same phenomenon holds true in the open ocean. Natural currents tend to lift the nutrient-rich and colder deeper waters toward the surface in certain locations. The result is significantly enhanced sea life in these locations, resulting from an increase in nutrients (nitrogen, phosphorus, etc.) in the upper photic zone of the ocean.

A reduction in surface water temperature in the open ocean could produce several desirable results. First, a substantial reduction over a broad area could substantially reduce the strength of a tropical cyclone moving into that area. Second, existing fisheries could be enhanced and new fisheries could potentially be created. Third, the action of air bubble steams can affect the wave field in a storm, reducing wave breaking and thereby offering the potential for protecting sensitive structures (e.g., deep sea oil drilling platforms) from destruction by storm waves. And fourth, the ability to alter the surface water temperature at specific points or over a broad area would allow enhanced oceanographic research—possibly allowing a more detailed understanding of existing natural phenomena.

### BRIEF SUMMARY OF THE INVENTION

The present invention seeks to bring ocean water from a considerable depth to the surface using airlift systems. A bubble of air released in the ocean will rise to the surface. If a gas diffuser is employed to release millions of bubbles of air, the rising cloud of bubbles will entrain the surrounding water and pull it toward the surface. It is possible to lift a great deal of water in this fashion, with a ¼ HP compressor being able to lift as much as 400,000 L per hour.

### BRIEF DESCRIPTION OF THE SEVERAL VIEWS OF THE DRAWINGS

FIG. 1 is an isometric view, showing the structure of the upper ocean.

FIG. 2 is an isometric view, showing the operation of a submerged diffuser.

FIG. 3 is an isometric view, showing the details of a proposed submerged diffuser.

FIG. 4 is an isometric view, showing a pair of submerged diffusers being towed behind a ship.

FIG. 5 is an isometric view with a cutaway, showing a siphon-type lift tube.

FIG. 6 is an isometric view, showing a ring of submerged diffusers.

### REFERENCE NUMERALS IN THE DRAWINGS

| | | | |
|---|---|---|---|
| 10 | upper ocean | 12 | thermocline |
| 14 | deep ocean | 16 | gas diffuser |
| 18 | bubble cone | 20 | entrained flow |
| 22 | nozzle assembly | 24 | nitrogen tank |
| 26 | trim tank | 28 | ship |
| 30 | tow line | 32 | siphon assembly |
| 34 | siphon tube | 36 | gas injector |

### DETAILED DESCRIPTION OF THE INVENTION

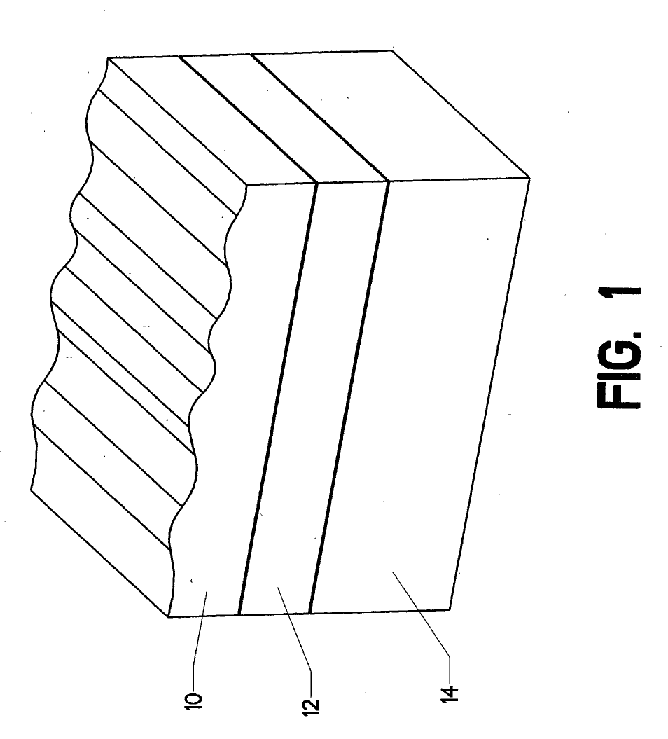

FIG. 1 is a simplified representation of the stratification of ocean water. Upper ocean 10 typically has a thickness of 25-75 m. This is the region subject to sunlight infiltration and surface wave action. It comprises generally warmer water, particularly in tropical and subtropical regions. Just beneath the lower limit of upper ocean 10 begins a region known as thermocline 12. The water temperature is relatively constant within upper ocean 10, only gradually dropping with increasing depth. However, the water within thermocline 12 exhibits a substantial temperature drop with increasing depth. Thermocline 12 can be quite thin, typically being only a few meters thick in tropical and arctic regions. In other areas, particularly in subtropical regions, thermocline 12 can be much thicker—ranging up to 100 m or more.

Thermocline 12 behaves like an elastic barrier. Surface wave action can sometimes reach down as far as thermocline 12, but rarely with sufficient force to breach it. Below thermocline 12 lies deep ocean 14. Deep ocean 14 contains cold water. The water temperature within deep ocean 14 does decrease with increasing depth, but only at a slow rate. Thus, as an observer descends through the ocean layers described, he or she would experience the following: a gradual temperature drop during the descent through upper ocean 10, followed by a sharp temperature drop during the descent through thermocline 12, followed by a gradual temperature drop during the descent through deep ocean 14. The reader will therefore appreciate that the water found in deep ocean 14 is substantially colder than the water found in upper ocean 10.

The significant ramification of this stratification is that during summer and fall the colder deeper water rarely penetrates thermocline 12 and into upper ocean 10. There are, however, instances where upwelling does occur. Some natural ocean currents cause a localized upwelling of deep water. This deep water, which is generally rich in nutrients, often creates an area that supports a rich variety of marine life, including commercially valuable fish.

Another instance where cold water is brought to the surface occurs during the violent wave and current action created by tropical cyclones. A tropical cyclone, which may create 30 m waves, will often breach and locally destroy thermocline 12. A turbulent mixing of surface and deeper waters then occurs, resulting in the colder water temperatures often measured after the passage of such a cyclone.

The primary goal of the present invention is a significant localized reduction in ocean surface water temperature using artificial and controllable means. It is well know that a gas bubble released in deep water will rise to the surface. If many thousands of such gas bubbles are released in a cloud, they tend to entrain the surrounding water as they rise. Thus, the rising bubbles carry a significant volume of water with them. If a gas diffuser (bubble generator) is placed below thermocline 12, the bubbles it releases will tend to breach thermocline 12 and produce a localized upwelling of colder ocean water.

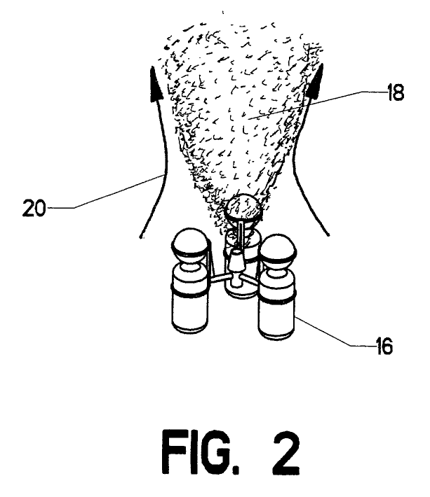

Those skilled in the art will realize that the thermal capacitance of even a relatively small section of ocean is enormous. It is therefore necessary to provide a device capable of lifting large quantities of deep water to the surface. FIG. 2 illustrates one such device. Gas diffuser 16 is suspended in the ocean below the thermocline. It steadily produces bubble cone 18—which comprises millions of gas bubbles rising toward the surface. Entrained flow 20 results. The water immediately within bubble cone 18—as well as the immediately surrounding water—is lifted toward the surface. The reader will appreciate that as the bubbles within bubble cone 18 continue to rise, bubble cone 18 assumes a more cylindrical shape.

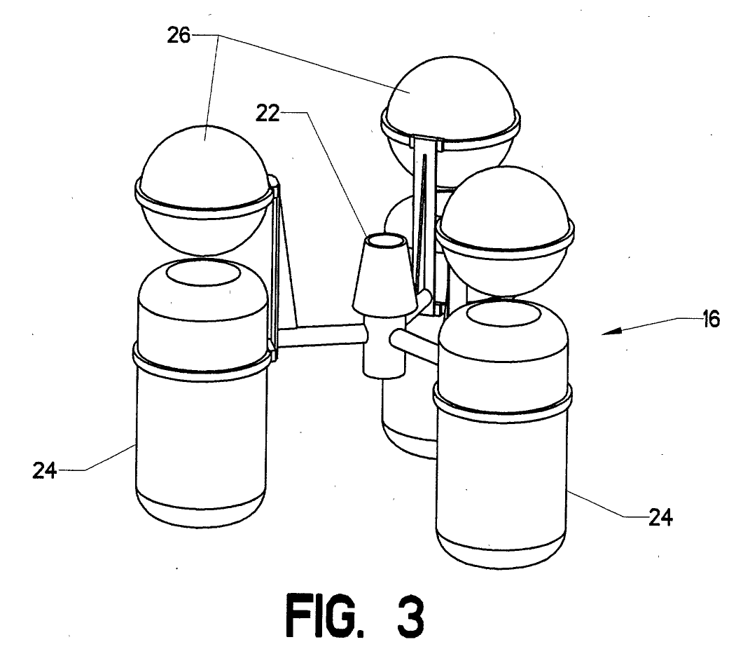

FIG. 3 shows gas diffuser 16 in more detail. At its center is nozzle assembly 22, which actually injects the gas into the surrounding ocean water. Extending radially outward from gas diffuser 16 are three tank assemblies. Each tank assembly has a trim tank 26 on top and a nitrogen tank 24 on bottom. The nitrogen is preferably stored in liquid form in order to minimize the required volume of nitrogen tank 24.

Of course, liquid nitrogen has a specific gravity less than 1, meaning it would tend to rise if placed in water. The weight of the tankage and other elements, however, ensure that gas diffuser 16 will sink. It is therefore necessary to regulate its buoyancy so that it can be released at the surface and then descend to a desired depth. It would also be preferable to enable it to subsequently rise to the surface when its gas supply is exhausted. Trim tanks 26 perform this function. Trim tanks 26 are initially filled with gaseous nitrogen (bled from nitrogen tanks 24). In this condition, gas diffuser 16 floats. When the time comes to place the device in operation, trim tanks 26 are vented and allowed to fill with seawater. Gas diffuser 16 then begins to sink.

As it descends, gaseous nitrogen can be used to blow the seawater partially out of trim tanks 26—thereby regulating depth. When the desired depth is achieved, trim tanks 26 are blown and filled periodically to regulate the depth. Gas diffuser 16 grows lighter and lighter as its liquid nitrogen supply is exhausted. It is therefore necessary to continually regulate its buoyancy in order to maintain the desired depth.

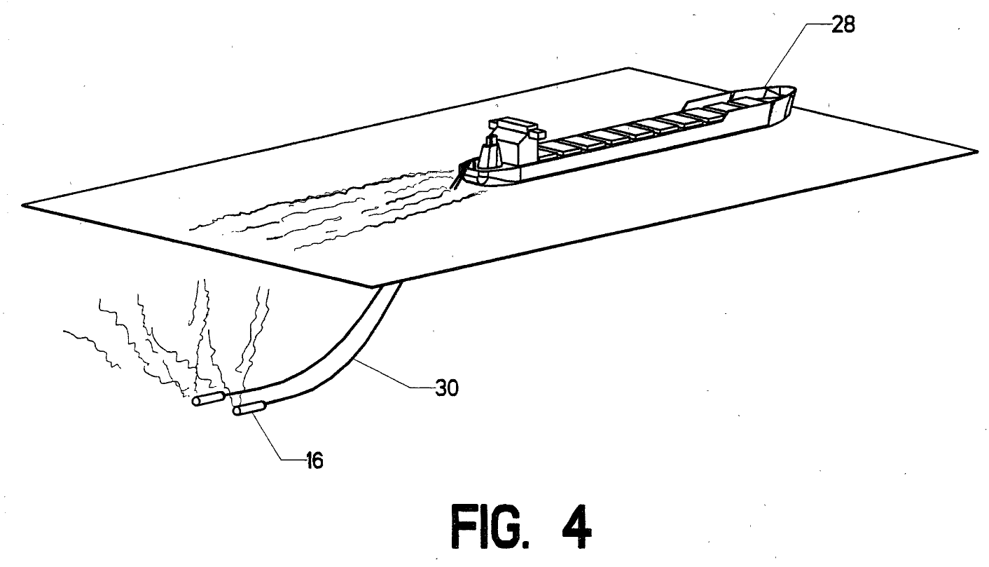

FIG. 4 illustrates a second possible embodiment. Ship 28 tows a plurality of diffusers 16 using tow lines 30. Tow lines 30 comprise a strong towing cable and a pressurized gas feed line. Each gas diffuser 16, which is formed in a torpedo-like shape, must carry ballast tanks and steering vanes to regulate its depth and course. These control features may be regulated from ship 28 via electronic circuitry, which would also be connected through tow lines 30. Large air compressors located on ship 28 pull in ambient air, compress it, and feed it down to the towed gas diffusers 16.

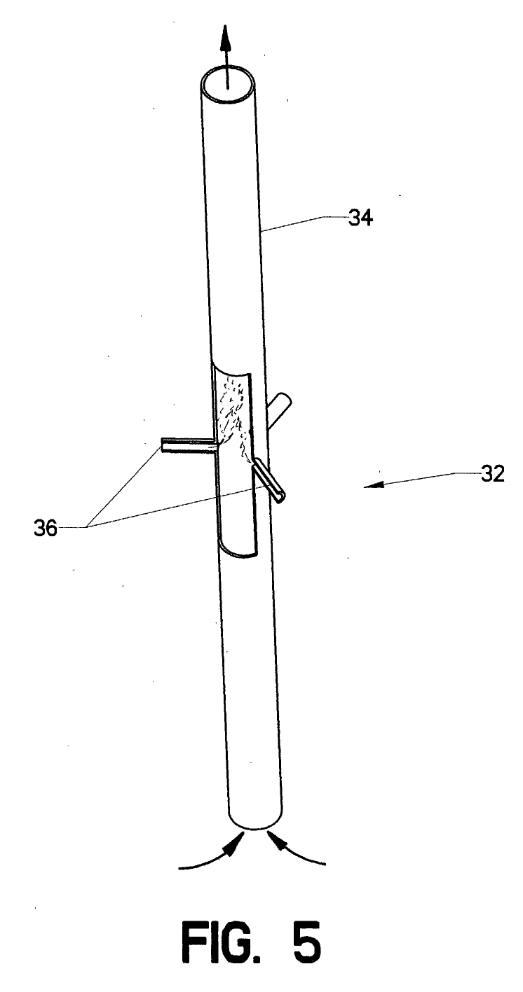

FIG. 5 illustrates a third possible embodiment. Siphon assembly 32 comprises siphon tube 34 (sometimes known as an “education tube”) and three gas injectors 36. Siphon tube 34 is a long hollow tube, which in actuality would be much longer than illustrated in FIG. 5. Its top and bottom is open. The top is placed in the upper ocean near the surface. The bottom is placed in the cold water below the thermocline. Gas bubbles are then injected via gas injectors 36 (a cutaway is illustrated to show the internal bubbling). As the gas bubbles rise, they entrain the water within the upper portion of the tube and cause it to rise as well. This rising current then pulls water into the lower portion of the tube by siphon action. The result is that cold water is drawn into the bottom of siphon tube 34, lifted, and discharged out its top.

These second and third embodiments both have disadvantages. The ship-borne device is impractical in heavy seas, as tow lines 30 would tend to part. It is particularly useful to employ the gas diffusion lifting devices in a heavy sea—for reasons to be explained subsequently. This drawback is therefore a serious one.

The siphon assembly must be suspended vertically in order to function. If it is attached to the sea floor, then it can only be used in shallow areas. If it must be free-floated, then it will be subject to significant destructive forces by wave and current action (owing to its long and slender nature). Thus, the embodiment disclosed in FIGS. 2 and 3 is the preferred embodiment.

As discussed previously, the utility of the device is found in three proposed applications: (1) amelioration of tropical cyclones (hurricanes and typhoons); (2) restoration or enrichment of ocean fisheries; and (3) oceanographic research.

Data indicates that tropical cyclones can only arise when the water surface temperature exceeds 26° C. When a cyclone which has already formed crosses a region having water surface temperatures below 26° C., the cyclone rapidly loses strength and often disintegrates. If an artificial region of cool surface temperature can be created in the path of an oncoming cyclone, it may be possible to weaken or destroy the cyclone.

This objective necessitates the creation of a large cold water region (50×100 km, approximately). Preliminary calculations indicate that 10 to 100 billion cubic meters of cold ocean water would have to be lifted to the surface to effect such a dispersed temperature change. It is therefore important to determine how much gas would be required to lift such an enormous volume of water by the diffusion method.

1 L of liquid nitrogen yields approximately 700 L of gaseous nitrogen at 1 atmosphere. A 2 cubic meter container of liquid nitrogen would therefore produce approximately 1.4 million L of gaseous nitrogen. Of course, these computations do not hold for higher pressures. At a depth of 200 m, the ocean pressure is approximately 20 atmospheres. At this pressure, the same volume of liquid nitrogen would yield only 70,000 L. A volume of 70,000 L will operate a large capacity diffuser (100 L/minute) for 12 hours. It is therefore possible that an evenly distributed area of 5000 submerged diffusers could lift a volume of water sufficient to cool 5000 square km of ocean surface below 26° C.

It may be found that single diffusers do not provide sufficient lift to raise such a massive volume of water. In this case, circular arrays of diffusers could be employed to increase the water lift. The assumption is that a circular array could induce an entire column of water to move upwards. If this result can be produced, then the quantity of water lifted will increase exponentially with the square of the radius of the diffuser array. As an example, a diffuser array with a diameter of 60 m can be constructed using 7 diffusers, 6 distributed along the circle's perimeter and one being located in the center. As a result, the average distance between individual diffusers would be about 30 m. Preliminary experiments performed in a water tank indicate that the average speed of bubbles rising through water is 0.5 m/sec. The average speed of the resulting water column is about 0.25 m/sec. If this can be duplicated for an entire 60 m circular diffuser array, then each array would lift about 42,000 cubic meters of water per minute. Over a 12 hour bubbling period, this would amount to more than 30 million cubic meters per array. If 1000 such bubbling arrays are placed in the ocean distributed over 5000 square kilometers in the path of an approaching hurricane, the total amount of cold water lifted would be in excess of 30 billion cubic meters over 12 hours of operation. This result is well within the 10-100 billion cubic meter estimate of the amount of cool water needed to cool the ocean to the desired temperature (i.e., less than 26° C.).

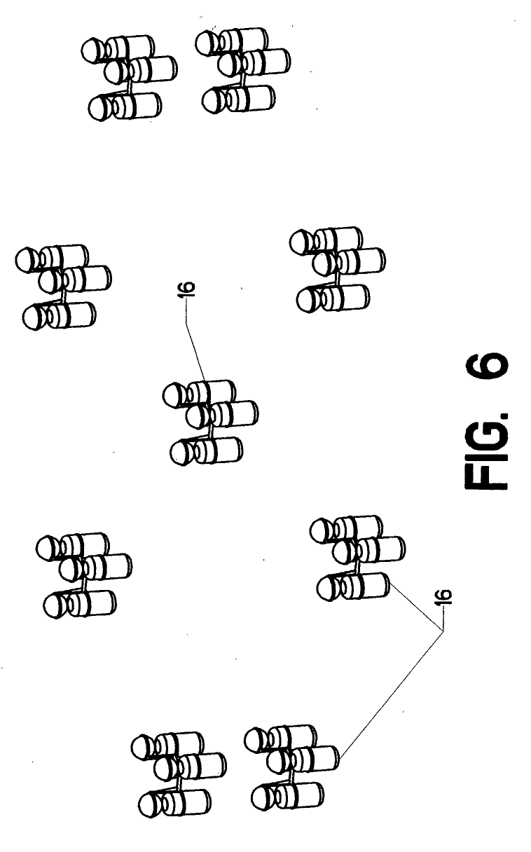

The ring of diffusers could be varied considerably in diameter and arrangement, in order to optimize the lifting capacity. FIG. 6 shows a ring of 9 diffusers 16 arrayed in a circle having a diameter of 60 m—with one diffuser 16 being in the center. Larger arrays are possible, reaching diameters of 100 m or more. Smaller diameters are also possible. For a small diameter array (perhaps 20 m or less) the center diffuser 16 can likely be eliminated.

Non-circular arrays are also possible. These are more effective for larger areas—since maintaining a ring shape would then result in large open spaces in the ring's interior. A grid structure placing the diffusers at the intersection points is one approach to covering a larger area.

There are several potential variables that could modify the preceding computations. First, gases tend to be highly soluble in cold water at high pressures. Thus, a significant portion of the injected nitrogen gas could become dissolved in the sea water. Second, gas bubbles are most efficient in lifting water when they are relatively small (1-3 mm in diameter). As the gas bubbles rise through lower and lower surrounding water pressure, the bubbles expand and merge into one another. This phenomenon may be limited, however, by the fact that larger bubbles tend to become unstable and fracture back into smaller bubbles. This tendency might be enhanced by propagating periodic ultrasonic pulses through the sea water.

A third unknown factor is the potential outgassing of gases naturally dissolved in the sea water. Deep ocean water is generally not fully saturated with gas. It is oversaturated, however, in comparison with the surface water lying above it (since the surface water is under much lower pressure). As the deep water is lifted, significant spontaneous outgassing may occur—substantially augmenting the artificial bubbles.

A fourth unknown factor involves the structure of the thermocline itself As explained previously, the strong thermocline encountered in subtropical oceans during the hurricane season (summer and fall) is not typically breached by normal ocean currents. It becomes strained, however, during the approach of a tropical cyclone. If a small number of diffusers could be employed to weaken the thermocline, the strong ocean currents which naturally occur in the path of a cyclone might be able to destroy the thermocline well ahead of the storm. The result would be a substantial upwelling of deep water and cooling of the ocean surface ahead of the storm. Thus, it may be possible to achieve the goal of cyclone amelioration using far fewer diffusers than the raw lifting calculations would suggest.

The invention may also be useful in the restoration or enrichment of ocean fisheries. Fish stocks in large areas of the world's oceans periodically experience disastrous declines due to temperature induced stagnation of the upper ocean. Under normal conditions, upwelling of nutrient-rich deep ocean waters provides a plentiful supply of minerals such as phosphor and nitrogen. These minerals are essential for the growth of phytoplankton, the plant life that forms the base of the aquatic food chain.

During periods of ocean warming the upwelling ceases, nutrients in the photic zone are depleted, phytoplankton growth slows, and the fisheries collapse. This problem may be solved by artificially restoring the upwelling of cold water using the gas bubble lifting approach. As these fisheries tend to exist in fixed locations, the use of a fixed siphon tube (as in FIG. 5) might be desirable.

A third application for the proposed technology would be protection of man-made structures against the destructive force of storm waves. This application does not depend on lifting cold water to the ocean surface. The principle here is that water mixed with air bubbles has a lower specific density than pure water. Thus, the presence of a plume of air bubbles alters the wave field. In a sense, the waves are dampened by “sinking” into the region of lower density at the bubble plume. This effect can be used to reduce the destructive force of storm waves and protect man-made structures at sea (such as oil drilling platforms). Depending on the local topography, the effect may also prove useful for protecting on-shore and near-shore structures, like harbors.

A fourth general area of application for the proposed invention is oceanographic research. Unlike chemistry and physics, oceanography is still largely a descriptive science. It is generally not possible to perturb the ocean conditions in a controlled fashion and measure the results. Thus, oceanographers have traditionally been limited to observing natural phenomena. The proposed invention would provide oceanographers with a tool which could perturb ocean conditions over a substantial area. Conventional measuring devices could then be employed to measure the effects of the perturbation. Such studies could provide valuable information on the configuration, stability, and regenerating capacity of the thermocline, warm and cold water eddies, and other upper ocean structures.

Other potential applications of the bubble lift systems include pollution control and environmental engineering. An airlift curtain could conceivably be employed to contain an oil slick spreading on the ocean surface. Aeration of certain ocean regions could also speed microbial breakdown of toxins introduced by human activities. Bubble streams could also be used to clean coral reefs by flushing away sediments. Many other applications are possible, depending on the ultimate efficacy of the lifting system.

1. A method of lifting a volume of water within an ocean wherein said ocean includes an upper ocean, a deep ocean, and a thermocline therebetween, comprising:
a. suspending a plurality of gas diffusers below said thermocline, wherein said gas diffusers are suspended at a nearly uniform depth, and wherein said plurality is spaced evenly apart so that each successive gas diffuser is less than 100 meters from its neighbors; and
b. injecting a continuous stream of gas bubbles from each of said plurality of gas diffusers into said deep ocean, so that when said stream of gas bubbles rises, it will entrain the surrounding water, causing said entrained water to rise upward, breach said thermocline, and rise into said upper ocean.

2. The method as recited in claim 1, wherein said plurality of gas diffusers are arranged in a circle, having one of said diffusers located at the center of said circle, with the remainder of said plurality being spaced along the circumference of said circle.

3. The method as recited in claim 1, wherein said plurality of gas diffusers are arranged in a circle, being evenly spaced along the circumference of said circle.

4. The method as recited in claim 2, wherein said circle has a diameter between 5 meters and 100 meters.

5. The method as recited in claim 3, wherein said circle has a diameter between 5 meters and 100 meters.

6. The method as recited in claim 1, wherein said stream of gas bubbles is supplied by tanks of liquefied gas mounted on said plurality of gas diffusers.

7. The method as recited in claim 1, wherein said stream of gas bubbles is supplied to said plurality of gas diffusers by gas lines extending from said upper ocean down to said gas diffusers.

8. The method as recited in claim 5, wherein said gas lines originate in a vessel resting on the surface of said ocean.

9. The method as recited in claim 6, wherein said ship tows said plurality of gas diffusers through said ocean at a nearly constant depth.

10. A device for lifting a volume of water within an ocean wherein said ocean includes an upper ocean, a deep ocean, and a thermocline therebetween, comprising:
a. a plurality of gas diffusers suspended below said thermocline, wherein said gas diffusers are suspended at a nearly uniform depth, and wherein said plurality is spaced evenly apart so that each successive gas diffuser is less than 100 meters from its neighbors; and
b. a gas supply, capable of injecting a continuous stream of gas bubbles from each of said plurality of gas diffusers into said deep ocean, so that when said stream of gas bubbles rises, it will entrain the surrounding water, causing said entrained water to rise upward, breach said thermocline, and rise into said upper ocean.

11. The device as recited in claim 10, wherein said plurality of gas diffusers are arranged in a circle, having one of said diffusers located at the center of said circle, with the remainder of said plurality being spaced along the circumference of said circle.

12. The device as recited in claim 10, wherein said plurality of gas diffusers are arranged in a circle, being evenly spaced along the circumference of said circle.

13. The device as recited in claim 11, wherein said circle has a diameter between 5 meters and 100 meters.

14. The device as recited in claim 12, wherein said circle has a diameter between 5 meters and 100 meters.

15. The device as recited in claim 10, wherein said gas supply comprises tanks of liquefied gas mounted on said plurality of gas diffusers.

16. The device as recited in claim 1, wherein said gas supply comprises gas lines extending from said upper ocean down to said gas diffusers.

17. The device as recited in claim 16, wherein said gas lines originate in a vessel resting on the surface of said ocean.

18. The device as recited in claim 17, wherein said plurality of gas diffusers are configured to be towed through said ocean by said vessel at a nearly constant depth.

19. A device for lifting a volume of water within an ocean wherein said ocean includes an upper ocean, a deep ocean, and a thermocline therebetween, comprising:
a. a siphon tube, having a hollow interior, and having an open upper end and an open lower end;
b. wherein said upper end is placed within said upper ocean above said thermocline;
c. wherein said lower end is placed within said deep ocean below said thermocline;
d. at least one gas injector, positioned to inject a continuous stream of gas bubbles into said hollow interior of said siphon tube, so that said stream of gas bubbles will rise within said hollow interior, entraining the water within said hollow interior and causing it to rise, thereby creating a siphon effect which draws water into said lower end, lifts it through said siphon tube, and discharges it out said upper end.
